(19) United States
(12) Patent Application Publication
(10) Pub. No.: US 2022/0413161 A1
(43) Pub. Date: Dec. 29, 2022

(54) INDOOR-OUTDOOR DUAL-USE HIGH PRECISION POSITIONING SYSTEM

(71) Applicant: Magellan Systems Japan, Inc., Hyogo (JP)

(72) Inventor: Nobuhiro KISHIMOTO, Hyogo (JP)

(21) Appl. No.: 17/901,353

(22) Filed: Sep. 1, 2022

Related U.S. Application Data
(63) Continuation of application No. PCT/IB2021/051586, filed on Feb. 26, 2021.
(60) Provisional application No. 62/985,214, filed on Mar. 4, 2020.

(51) Int. Cl. G01S 19/25; G01S 19/43

(52) U.S. Cl. CPC G01S 19/25; G01S 19/43

(57) ABSTRACT

Outdoor positioning for a plurality of mobile terminals is performed using an indoor positioning system including a plurality of base stations, by (a) installing the plurality of base stations on respective outdoor locations in an outdoor area, where the base stations are configured to use a predetermined communications link for indoor positioning at indoor locations, (b) performing independent precise positioning at each of the plurality of base stations using a plurality of GNSS signals, thereby determining a precise position of the outdoor location of each base station without surveying or measuring the installed location thereof, and (c) performing outdoor positioning of the plurality of mobile terminals in the outdoor area using the determined precise position of each of the plurality of base stations in a same manner as the indoor positioning, by receiving, at the plurality of base stations, signals from the respective mobile terminals via the predetermined communications link.

### CLAIM OF PRIORITY

This application is a Continuation of International Application No. PCT/IB2021/051586 filed on Feb. 26, 2021, which claims benefit of U.S. Provisional Patent Application No. 62/985,214, filed on Mar. 4, 2020. The entire contents of each application noted above are hereby incorporated by reference.

### BACKGROUND OF THE INVENTION

### 1. Field of the Invention

The present invention relates to a high precision positioning system which provides outdoor positioning using an indoor positioning system including a plurality of base stations (locators). More specifically, the present invention provides a local indoor-outdoor dual use positioning infrastructure with high precision by implementing an independent positioning function such as Precise Point Positioning-Real Time Kinematic (PPP-RTK) or Precise Point Positioning (PPP).

### 2. Description of the Related Art

Outdoor positioning has been highly developed utilizing Global Navigation Satellite Systems (GNSS). The GNSS available today include United States Global Positioning System (GPS), Russian Global Orbiting Navigation Satellite System (GLONASS), European Union's Galileo, China's BeiDou Satellite Navigation System (BDS, formerly known as Compass), and Japanese Quasi-Zenith Satellite System (QZSS).

In conventional relative positioning techniques such as Real Time Kinematic (RTK) positioning, Differential GNSS (DGNSS) technique, and the like, it is necessary to have the precise position (coordinates) of a reference station so as to generate error correction information such as pseudo-range correction (PRC) information to improve positioning accuracy. The PRC information created at the reference station is provided via communications links, such as a radio beacon, Networked Transport of RTCM via Internet Protocol (NTRIP), Digital Multimedia Broadcasting (DMB), Radio Date System (RDS), FM data Radio Channel (DARC), etc. For example, Radio Technical Commission for Maritime Services (RTCM) provides a transmission standard that defines the data structure for differential correction information for a variety of differential correction applications.

On the other hand, since the GNSS signals are not readily available in indoor positioning, it is necessary to install an indoor positioning infrastructure including a plurality of base stations (locators or beacons) covering the indoor area. A position of a rover (mobile terminal device) within the indoor area is measured or detected by communicating with the base stations via an indoor communications link. For example, radio wave-based communications such as Bluetooth Low Energy (BLE), Ultra Wideband (UWB), Wi-Fi, ultrasonic communications, Indoor Messaging System (IMES) using GPS-compatible signals, and the like, may be used as such an indoor communications link. A suitable communications link would be employed depending on the required precision and the cost of the implementation of the indoor positioning system. In addition, in order to set up an indoor positioning infrastructure, the precise position of each of the base stations and/or relative positions among the base stations should be known. Such positions are typically obtained by measuring the installed location of the base stations.

For example, in a real-time indoor positioning system, a tag (mobile terminal) transmitting a radio signal is attached to a positioning target such as a person, product, tool, or equipment. The radio signal transmitted from the tag is received by a plurality of sensor-receivers installed on predetermined or premeasured locations in an indoor area so as to determine a precise position of the tag and thus that of the positioning target. Such sensor-receivers may be arranged with a certain interval, depending on the strength of the radio signal and necessary precision for the positioning. The UWB positioning (8.5 to 9.5 GHz) may be used for such a real-time positioning with the interval of 30 to 40 m.

Conventionally, seamless outdoor-indoor positioning schemes employ a mobile terminal (rover) which is capable of processing both of the GNSS signals for outdoor positioning and indoor positioning signals sent from the base stations, such that the mobile terminal is able to calculate and determine its own position wherever it is: indoor or outdoor. The mobile terminal may automatically switch from one positioning to the other, depending on the positioning environment, with or without an additional mechanism for notifying the mobile terminal of the change in the environment. Such a mobile terminal may be implemented in a smart phone, a tablet, and the like, carried by a positioning target such as an office worker, a security person moving in and out of a building, or a worker in a factory or construction site.

### BRIEF DESCRIPTION OF THE INVENTION

However, in many real-time indoor positioning applications, as mentioned above, the mobile terminal is a tag for transmitting signals, and thus it has a very limited computational capacity, and thus such a tag is not suitable for processing the positioning signals, whether GNSS signals or indoor positioning signals. Accordingly, the positioning is performed by the sensor-receivers (indoor base stations or locators), and thus it is not possible to seamlessly provide a corresponding outdoor positioning using the same tag once the positioning target bearing the tag leaves the indoor positioning area. Thus, in order to provide a desirable seamless indoor-outdoor positioning system, the mobile terminals are provided with smart phone-level functions having suitable signal processing and positioning capabilities. However, providing such function as well as the necessary hardware to each positioning target might become too costly if the number of positioning targets increases. In some applications, it may be desirable that the mobile terminal is small and light-weighted so as to be easily wearable by or attachable to, for example, athletes or sports players.

Accordingly, in an aspect of the present invention, a method provides outdoor positioning for a plurality of mobile terminals (tags) using an indoor positioning system including a plurality of base stations (locators). The method includes (a) installing the plurality of base stations on respective outdoor locations in an outdoor area, where the base stations are configured to use a predetermined communications link for indoor positioning at indoor locations, (b) performing independent precise positioning at each of the plurality of base stations using a plurality of GNSS signals, thereby determining a precise position of the outdoor location of each base station without surveying or measuring the installed location thereof, and (c) performing outdoor positioning of the plurality of mobile terminals in the outdoor area using the determined precise position of each of the plurality of base stations in a same manner as the indoor positioning, by receiving, at the plurality of base stations, signals from the respective mobile terminals via the predetermined communications link.

In accordance with one embodiment of the present invention, the installing the plurality of base stations on the respective outdoor locations includes providing each of the plurality of base stations with a GNSS receiver configured to perform the independent precise positioning.

In accordance with one embodiment of the present invention, the performing independent precise positioning at each base station includes (b1) receiving, by the GNSS receiver, the plurality of GNSS signals from a plurality of GNSS satellites via a GNSS antenna so as to generate GNSS data, and (b2) performing positioning based on the GNSS data to calculate a current position of the base station without using position information of a reference station or external correction information received from a reference station.

The plurality of GNSS signals may include GNSS signals having centimeter-level augmentation information, where the GNSS data includes GNSS observation data and augmentation data obtained from the augmentation information.

The independent precise positioning may be precise Point Positioning (PPP) or Precise Point Positioning—Real Time Kinetic (PPP-RTK).

In accordance with one embodiment of the present invention, the method further includes (d) providing an indoor positioning mode and an outdoor positioning mode to each base station, and (e) storing, for each base station, position information of the indoor location of the base station which is known or has been measured for the indoor positioning mode, and position information of the precise position of the outdoor location determined after installing the base station in the outdoor positioning mode. The position information of the precise position of the outdoor location may include absolute position of the base station.

In accordance with one embodiment of the present invention, the predetermined communications link includes at least one of Bluetooth Low Energy using 2.4 GHz range radio frequencies, and Ultra Wideband communication using 8.5 to 9.5 GHz radio frequencies.

In accordance with another embodiment of the present invention, the installing the plurality of base stations on the respective outdoor locations includes (a1) providing each of the plurality of base stations with a first GNSS receiver configured to perform Real Time Kinematic (RTK) positioning, (a2) installing at least one reference station including a second GNSS receiver in a vicinity of the plurality of base stations, (a3) performing, using the second GNSS receiver, the independent precise positioning. In this case, the independent precise positioning performed by the second GNSS receiver includes (b3) receiving the plurality of GNSS signals including centimeter-level augmentation information, (b4) generating GNSS data from the received GNSS signals, the GNSS data including GNSS observation data and augmentation data obtained from the augmentation information, (b5) performing positioning based on the GNSS data to calculate a current position of the reference station without using position information of another reference station or external error correction information from another references station, (b6) generating error correction information in a predetermined data format based on results of the positioning, the error correction information including the current position of the reference station, and (b7) transmitting the error correction information to the respective base stations. Then, at each base station using the first GNSS receiver, the RTK positioning is performed using the error correction information, thereby calculating a position of the base station as the precise position of the outdoor location. The predetermined data format may be in accordance with standard correction data format of RTCM or CMR.

In another aspect of the present invention, a system provides outdoor positioning for a plurality of mobile terminals (tags) using an indoor positioning system. The system includes a plurality of base stations to be installed on respective outdoor locations in an outdoor area, where each of the plurality of base stations are configured to use a predetermined communications link for indoor positioning at indoor locations. Each base station includes (i) a GNSS receiver configured to perform independent precise positioning using a plurality of GNSS signals so as to determine a precise position of the outdoor location of the base station without using position information of a reference station or external correction information from a reference station, and (ii) a positioning receiver configured to receive signals from the plurality of mobile terminals within the area via the predetermined communications link, so as to perform outdoor positioning of the respective mobile terminals using the determined precise position of the base station in a same manner as the indoor positioning, thereby determining a current position of the respective mobile terminals.

In accordance with one embodiment of the present invention, the system further includes a controller configured to receive the determined current position of the mobile terminals from the plurality of the base stations.

In accordance with one embodiment of the present invention, each GNSS receiver is configured to receive, from a plurality of GNSS satellites, the plurality of GNSS signals including GNSS signals having centimeter-level augmentation information, thereby generating GNSS data including GNSS observation data and augmentation data, and to perform the positioning based on the GNSS data. The independent precise positioning may be precise Point Positioning (PPP) or Precise Point Positioning—Real Time Kinetic (PPP-RTK).

In accordance with one embodiment of the present invention, each of the plurality of base stations is provided with an indoor positioning mode and an outdoor positioning mode. Each base station may further include a memory for storing position information of the indoor location of the base station which is known or has been measured for the indoor positioning mode, and position information of the precise position of the outdoor location determined after outdoor installation of the base station in the outdoor positioning mode. The position information of the precise position of the outdoor location may include absolute position of the base station.

In accordance with one embodiment of the present invention, the predetermined communications link includes at least one of Bluetooth Low Energy using 2.4 GHz range radio frequencies, and Ultra Wideband communication using 8.5 to 9.5 GHz radio frequencies.

In yet another aspect of the present invention, a system provides outdoor positioning for a plurality of mobile terminals (tags) using an indoor positioning system. The system includes a plurality of base stations (locators) and at least one reference station. The plurality of base stations are installed on respective outdoor locations in an outdoor area, where each base station includes a positioning receiver configured to perform indoor positioning at respective indoor locations by receiving the signals from the plurality of mobile terminals via a predetermined communications link for indoor positioning, and a first GNSS receiver configured to perform Real Time Kinematic (RTK) positioning. The at least one reference station is installed in a vicinity of the plurality of base stations, where the reference station includes a second GNSS receiver and a correction signal processor. The second GNSS receiver is configured to perform independent precise positioning by receiving, from a plurality of GNSS satellites, a plurality of GNSS signals including GNSS signals having centimeter-level augmentation information, thereby determining a precise position of the reference station without using position information of another reference station or external correction information received from another reference station. The correction signal processor is configured to generate error correction information in a predetermined format, the error correction information including the precise position of the reference station, and to transmit the error correction information to the respective base stations. Thus, in each of the plurality of base stations, the first GNSS receiver performs the RTK positioning using the error correction information received from the reference station, thereby calculating a position of the base station at the outdoor location, while the positioning receiver performs outdoor positioning of the respective mobile terminals based on the signals received therefrom, using the calculated position of the base station at the outdoor location in a same manner as the indoor positioning, thereby determining a current position of the respective mobile terminals.

The system may further includes a controller configured to receive information of the determined current position of the mobile terminals from the plurality of the base stations. The predetermined data format may be in accordance with standard correction data format of RTCM or CMR.

In accordance with the method and system of the present invention, it is possible to provide an outdoor positioning infrastructure by simply bringing the indoor positioning system including the plurality of base station to an outdoor area, and installing the base stations on respective outdoor locations without measuring or surveying the position of the outdoor location, since each of the base stations is capable of performing the independent precise positioning to determine its own location using the plurality of GNSS signals. Accordingly, the same mobile terminals (tags) can be used in the outdoor positioning as well as in the indoor positioning, realizing a seamless indoor-outdoor positioning infrastructure.

When the outdoor positioning is performed for a predetermined closed area such as an outdoor sports field, construction site, farm, agricultural field, and the like, it may not necessary to perform the GNSS-based positioning for each of the positioning targets within such a limited area. In accordance with the embodiments of the present invention, the base stations are easily set up without conducting cumbersome measurement or survey to provide a suitable outdoor infrastructure.

The position of each base station may be determined as a relative position among the base stations. However, by determining the absolute positions (coordinates) of the respective base stations (outdoor installation location thereof), the positions of the base stations can be associated with that of the specific area for the outdoor positioning (or the ground) so as to observe or manage the movement of the mobile terminals (i.e., the positioning targets) with respect to the specific area. For example, movement of athletes such as football players with respect to the football field can be tracked, monitored, and/or recorded, by providing the mobile terminals (tags) to the athletes and installing the base stations around the field.

By employing the present invention, an indoor positioning system for an indoor sports field can be transported to a corresponding outdoor sports field and easily re-construct an outdoor positioning system using the same base stations and the mobile terminals, saving the cost for separately implementing the indoor and outdoor positioning system.

The present invention may also be used for agricultural application, in which, for example, a tractor may be provided with a mobile terminal (tag), and the base stations can be installed in a garage (indoor positioning), and around and/or along a road and fields (outdoor positioning) where the tractor is operated. The tractor will be positioned seamlessly from the garage to the field. Automatic carrier vehicles can also be provided with the tags, and the locators (base stations) can be installed in an indoor factory and an outdoor site such that the indoor-outdoor positioning infrastructure is seamlessly and easily provided for the automatic carrier vehicles.

### BRIEF DESCRIPTION OF THE DRAWINGS

The present invention is illustrated by way of example, and not by way of limitation, in the FIGS. of the accompanying drawings and in which like reference numerals refer to similar elements and in which:

FIG. 1 is a schematic diagram illustrating a system 100 which is used for indoor positioning in accordance with one embodiment of the present invention.

FIG. 2 is a functional block diagram illustrating a base station (locator) in accordance with one embodiment of the present invention.

FIG. 3 is a schematic diagram illustrating the system 100 which is used for outdoor positioning in accordance with one embodiment of the present invention.

FIG. 4 is a schematic diagram illustrating a system 200 used for outdoor positioning in accordance with another embodiment of the present invention.

FIG. 5 is a functional block diagram schematically illustrating a base station (locator) in accordance with another embodiment of the present invention.

FIG. 6 is a functional block diagram schematically illustrating a reference station in accordance with another embodiment of the present invention.

FIG. 7 is a diagram illustrating a method for providing outdoor positioning in accordance with one embodiment of the present invention.

FIG. 8 is a diagram illustrating an example of independent precise positioning of the base station in accordance with one embodiment of the present invention.

FIG. 9 is a diagram illustrating a method for providing outdoor positioning in accordance with another embodiment of the present invention.

FIG. 10 is a diagram illustrating an example of the independent precise positioning of the reference station in accordance with one embodiment of the present invention.

### DETAILED DESCRIPTION OF EMBODIMENTS OF THE INVENTION

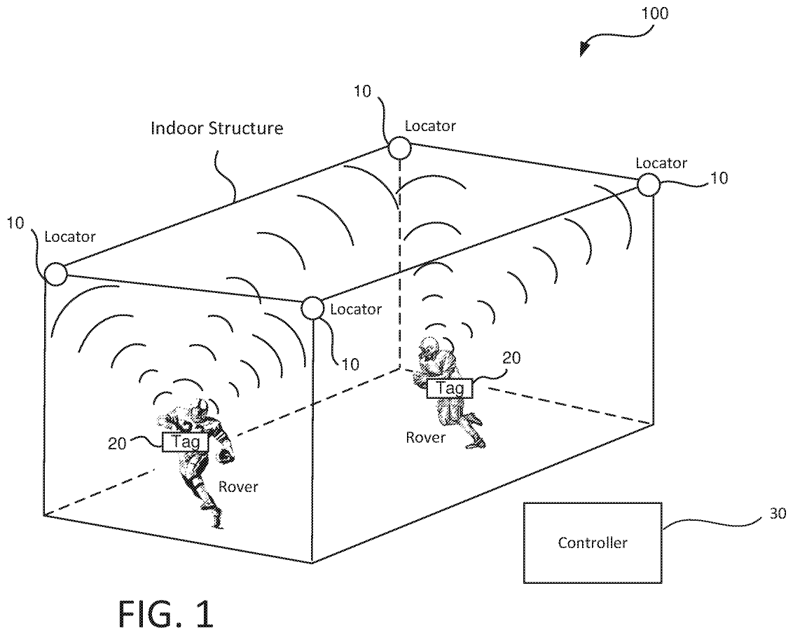

The present invention provides a method and system for providing outdoor positioning for a plurality of mobile terminals (tags) using an indoor positioning system including a plurality of base stations (locators). FIG. 1 shows an example of an indoor positioning system 100 including a plurality of base stations 10 which are also referred to as locators. The base stations 10 are installed in respective indoor locations, for example, mounted on ceilings, walls, and the like of an indoor structure. The base stations 10 may be detachably fixed to the indoor structure by providing a mounting base and a fixing mechanism or the like. “Indoor” means an area inside a certain structure, or an area in which GNSS signals from GNSS satellites are not received.

The fixed positions of the base stations 10 are precisely measured at the time of installation so as to determine at least relative special/positional relationships among the base stations 10. The measured relative positions of the base stations 10 may be mapped onto a diagram or plan view of the indoor structure so as to associate with the corresponding actual physical locations. The indoor positioning system 100 may include a controller 30 or a dedicated server in communication with the base stations 10 so as to process data obtained via the base stations 10.

Positioning targets (or rovers), such as people or things, for example, workers, athletes, players, security guards, vehicles, products, tools, equipments, and the like, are provided with mobile terminals 20 which are also referred to as tags. The mobile terminals 20 transmit RF signals via a predetermined communications links, such as Bluetooth Low Energy using 2.4 GHz range, or Ultra Wideband communication using 8.5 to 9.5 GHz. Wi-Fi communications link may also be used in certain applications.

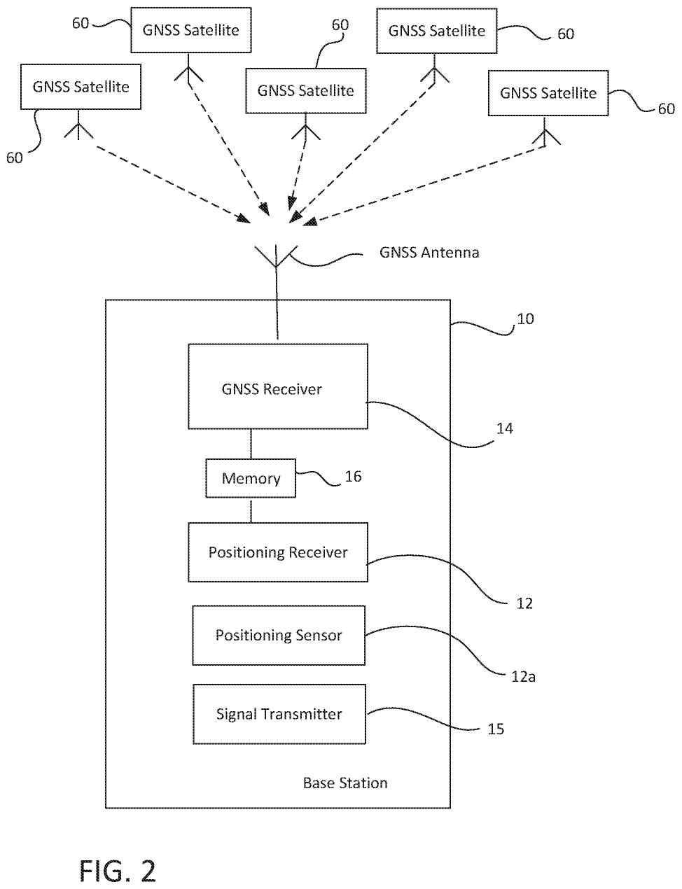

As shown in FIG. 2, each base station 10 includes a positioning receiver 12 with a positioning sensor 12a to receive the signals from the mobile terminals 20. The positioning receiver 12 may determine the direction in which the signals are received so as to calculate a two-dimensional position of a specific mobile terminal 20 by determining two angles (horizontal and vertical) of the signal direction. Such a specific mobile terminal 20 may be identified by a unique ID included in the signal indicating the source terminal 20. If two or more base stations 10 receive the signals from the same mobile terminal 20 at the same time, the three-dimensional location of the mobile terminal may be determined by the controller 30. The base station 10 may also include a signal transmitter 15 to communicate with the controller 30 and/or the mobile terminals 20.

In accordance with one embodiment of the present invention, the plurality of base stations 10 are also used for outdoor positioning by installing them on respective outdoor locations in a certain outdoor area, thereby providing seamless indoor-outdoor positioning for the same mobile terminals 20 using the same predetermined communications link as that of the indoor positioning. The base stations 10 may be installed on or attached to suitable outside structures, such as walls, fences, poles, roofs, and the like. Alternatively, the base station 10 may be provided with a mounting structure or set-up structure such as a tripod. The base stations 10 may be of a portable type. The base stations 10 may be installed with suitable intervals along or within the outdoor area to perform the outdoor positioning depending on the communications link to be used.

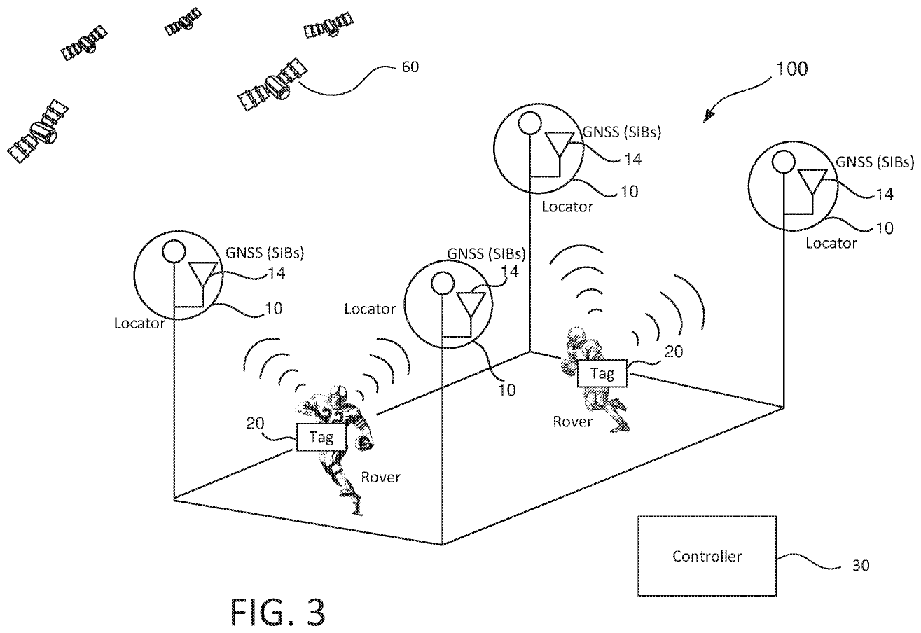

As shown in FIGS. 2 and 3, each base stations 10 includes a GNSS receiver 14 in addition to the positioning receiver 12. FIG. 3 specifically illustrates the positioning system 100 when it is deployed as an outdoor positioning infrastructure. The GNSS receiver 14 performs independent precise positioning using a plurality of GNSS signals received from a plurality of GNSS satellites 60, as to determine a precise position of the outdoor location of the base station 10. The independent precise positioning means that the precise positioning is performed without using position information of other reference station(s) or external correction information received from such a reference station.

More specifically, the GNSS receiver 14 has a self-contained high-precision positioning function such that, when it is turned on, the GNSS receiver 14 initializes itself and calculate its own position with high accuracy. “Self-containing” means that it does not employ relative positioning technology (such as RTK or DGNSS) which requires position information (known precise position) of other reference station(s). That is, contrary to conventional GNSS receivers, the GNSS receiver 14 (and the base station 10 including the GNSS receiver 14) in accordance with the present invention employs satellite-based high-precision positioning technology such as PPP or PPP-RTK using GNSS such as QZSS, without relying on other error correction information or position information received via non-satellite communication links such as the Internet. The implementation of the present invention may be configured as a computer including a CPU, a memory (RAM, ROM), and the like therein so as to have the illustrated functional blocks. These functional blocks may be realized by means of software/computer programs realizing the respective functions, but a part or the whole of them may be realized by hardware.

The plurality of GNSS satellites 60 from which the GNSS receiver 14 receives the GNSS signals include at least five GNSS satellites, and may include GNSS satellites transmitting GNSS signals having centimeter-level augmentation (CLA) information therein. For example, QZSS satellites transmit L6 signals having such centimeter-level augmentation information under the Centimeter Level Augmentation Information Service (CLAS) and Multi-GNSS Advanced Demonstration tool for Orbit and Clock Analysis (MADOCA). The GNSS satellites which are capable of transmitting the CLA information may be referred to as CLAS Satellites.

Utilizing such CLAS satellites, the GNSS receiver 14 receives the plurality of GNSS signals having centimeter-level augmentation information, thereby generating GNSS data including GNSS observation data and augmentation data, and performs the positioning based on the GNSS data. The independent precise positioning may be precise Point Positioning (PPP) or Precise Point Positioning—Real Time Kinetic (PPP-RTK).

The GNSS receiver 14 may include a GNSS data processor (not shown) for generating GNSS data based on the received GNSS signals. The GNSS data is data generated from the GNSS signals and includes GNSS observation data. It should be noted that the GNSS data processor includes a front end and other components (not shown) to process the received GNSS signals and produce the GNSS data. The GNSS data processor may perform acquisition and tracking of the received GNSS signals so as to produce the GNSS data, as is well understood by those of ordinary skill in the art. The GNSS observation data may include the travelling time ΔT of the GNSS signal to propagate from the satellite antenna (at the emission time) to the receiver (the receiver antenna), for example. The plurality of GNSS signals may include GNSS signals having centimeter-level augmentation information (CLA), and thus the GNSS data generated from the GNSS data processor may further include augmentation data obtained from the augmentation information in the GNSS signals.

For example, the GNSS observation data may be generated from the GNSS signals in the frequency range L1 and/or L2 and/or L5, and the centimeter-level augmentation data may be generated from the GNSS signals in the frequency range L6. The GNSS data processor may process the received GNSS signals together to generate the GNSS data including the GNSS observation data and the augmentation data. Alternatively, the GNSS receiver 14 may be configured such that the received GNSS signals are divided according to the frequency range such that the GNSS data processor processes the L1/L2/L5 signals and L6 signals separately so as to generate the GNSS observation data and the augmentation data through separate processing channels or using dedicated data processors.

Since the base station 10 is capable of performing stand-alone self-positioning so as to obtain the precise position without any measurement of its position, setting up the outdoor positioning infrastructure is greatly facilitated by simply installing the base stations 10 on suitable outdoor locations. As shown in FIG. 2, the precise position of the base station 10 determined by the GNSS receiver 14 may be stored, as position information, in a memory 16 thereof, which is also accessible from the positioning receiver 12. The position information of the precise position may include absolute position of the base station 10. So long as the memory 16 is accessible from both of the GNSS receiver 14 and the positioning receiver 12, the memory 16 can be implemented either within the GNSS receiver 14, within the positioning receiver 12, or outside of the both.

The positioning receiver 12 receives the signals from the plurality of mobile terminals 20 within the area via the predetermined communications link, which is also used for the indoor positioning. The positioning receiver 12 performs outdoor positioning of the respective mobile terminals 20 using the determined precise position of the base station 10 in the same manner as the indoor positioning. A current position of the respective mobile terminals 20 may be determined as a two-dimensional position using single base station 10, or as a three-dimensional position if two or more base stations 10 perform positioning for the same mobile terminal 20 at the same time, as mentioned above. The controller 30 may be used to process the data from the plurality of base stations 10 to determine and monitor the current positions of the plurality of the mobile terminals 20 in a real-time manner.

In accordance with one embodiment of the present invention, the base station 10 is configured as an indoor-outdoor dual-use base station and is provided with an indoor positioning mode and an outdoor positioning mode. The base station 10 may further store, in the memory 12, position information of the indoor location (fixed position) of the base station 10 which is known or has been measured when the base station is installed indoor, as well as the position information of the precise position of the outdoor location determined after outdoor installation of the base station 10. The indoor position information is used in the indoor positioning mode, and the outdoor position information is used in the outdoor positioning mode.

Such a dual-use base station 10 can be used indoor and outdoor interchangeably. For example, the base stations 10 may be detachably installed in the indoor location for indoor positioning, and then removed and transported to an outdoor area to provide an outdoor positioning infrastructure by installing suitable outdoor locations around and/or within the outdoor area. Since both of the base stations 10 and the mobile terminals 20 are commonly used for indoor positioning and outdoor positioning, it is possible to save the cost for the hardware. The base stations 10 may be returned to the original indoor locations after their outdoor use.

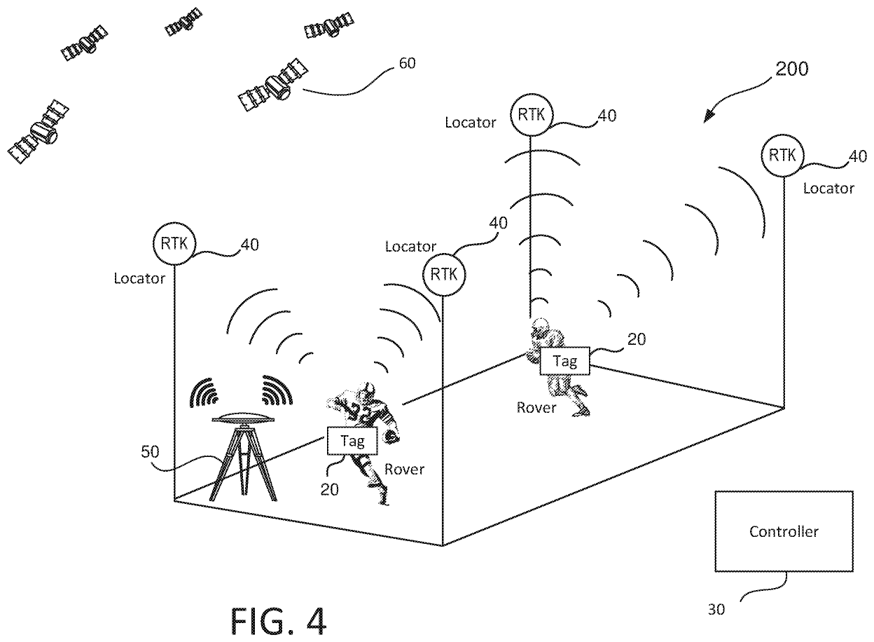

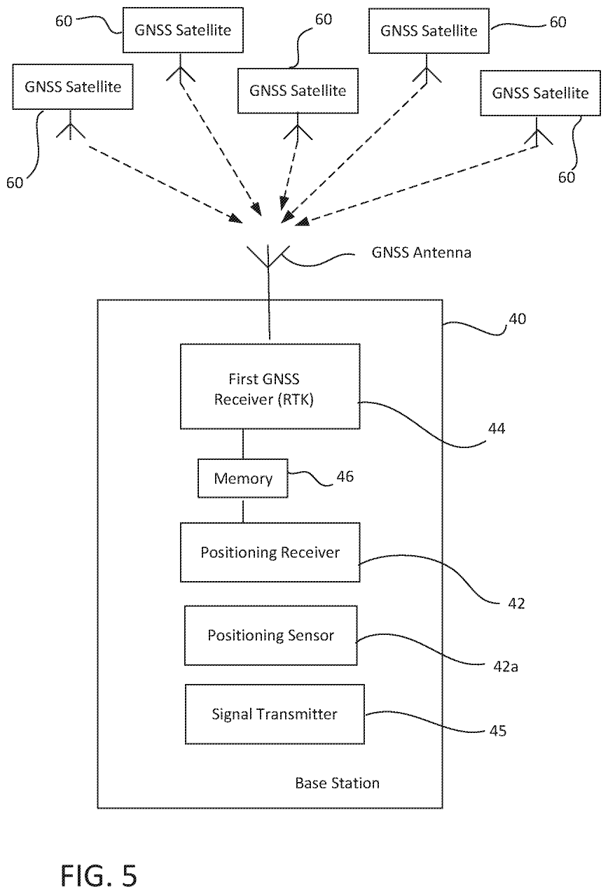

FIG. 4 schematically illustrates a system 200 in accordance with another embodiment of the present invention. The system 200 provides outdoor positioning for a plurality of mobile terminals (tags) 20. The system 200 includes a plurality of base stations (locators) 40 and at least one reference station 50, such that independent precise positioning of the system 200 is performed in combination of the base stations 20 and the at least one reference station 50. In this embodiment, as shown in FIG. 5, the base stations 40 includes a positioning receiver 42 which may be the same as the positioning receiver 12 of the base station 10, and may include a positioning sensor 42a.

The positioning receiver 42 is capable of performing indoor positioning at respective indoor locations, as well as outdoor locations, by receiving the signals from the plurality of mobile terminals 20 via a predetermined communications link for indoor positioning, similarly to the positioning receiver 12. The base station 40 further includes a first GNSS receiver 44 which is configured to perform Real Time Kinematic (RTK) positioning. As shown in FIG. 4, the system 200 may further include a controller 30 configured to receive information of the determined current position of the mobile terminals 20 from the plurality of base stations 40, similarly to that in the system 100. As shown in FIG. 5, the base station 40 may also include a signal transmitter 45 to communicate with the controller 30 and/or the mobile terminals 20.

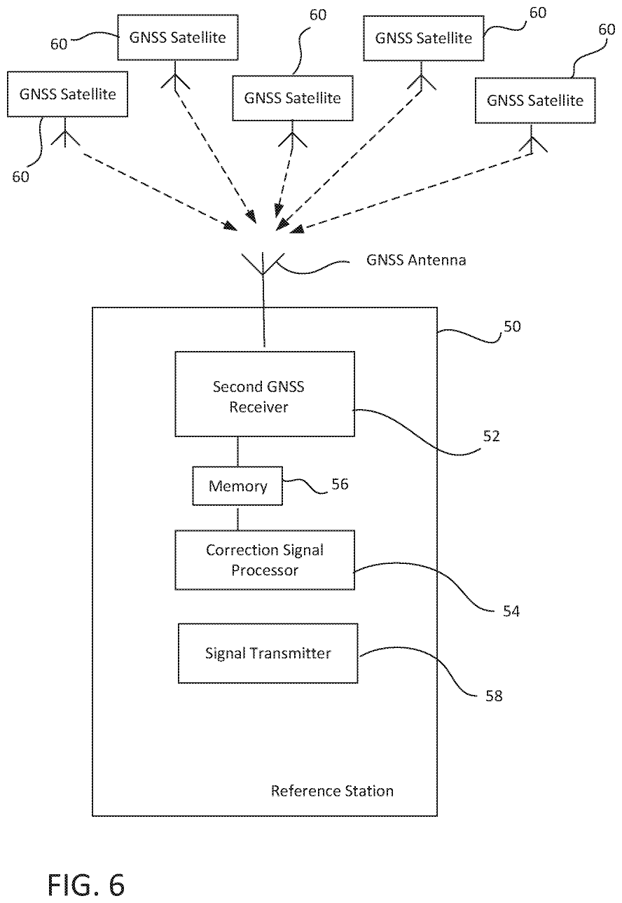

The at least one reference station 50 is installed in the vicinity of the plurality of base stations 40. As shown in FIG. 6, the reference station 50 includes a second GNSS receiver 52 and a correction signal processor 54. Similarly to the GNSS receiver 14, the second GNSS receiver 52 is configured to perform independent precise positioning by receiving, from a plurality of GNSS satellites 60, a plurality of GNSS signals which include GNSS signals having centimeter-level augmentation information. The GNSS receiver 52 determines a precise position of the reference station 50 without using position information of another reference station or external correction information received from another reference station, in the same manner as the GNSS receiver 14 determines the precise position of the base station 10.

The correction signal processor 54 generates error correction information in a predetermined format. The error correction information includes the precise position of the reference station 50. The reference station 50 transmits, though a signal transmitter 58, the error correction information to the respective base stations 40. Thus, in each of the plurality of base stations 40, the first GNSS receiver 44 receives the error correction information and performs the RTK positioning using the error correction information, thereby calculating a position of the base station 40 at the outdoor location. The positioning receiver 42 of the base station 40 performs outdoor positioning of the respective mobile terminals 20 based on the signals received therefrom, using the calculated precise position of the base station 40 at the outdoor location in the same manner as the positioning receiver 12 of the base station 10 does. The predetermined data format may be in accordance with the standard correction data format of RTCM or Compact Measurement Record (CMR). The reference station 50 may also generate and transmit GNSS observation data.

Since the error correction information includes the precise position (coordinates) of the reference station 50, as explained below, the base station 40 (the first GNSS receiver 44), which also receives the GNSS signals, is able to calculate and determine its position using the error correction information and the precise position of the reference station 50 included therein. That is, the first GNSS receiver 44 performs relative GNSS positioning so as to obtain its precise position based on the precise position of the reference station 50 by calculating the relative position with respect to the precise position of the reference station 50. After the base stations 40 have finished determining their own precise positions, the reference station 50 may be moved to another place or removed from the area so as not to obstruct movements of the mobile terminals (i.e., positioning targets).

It should be noted that since a distance (baseline) between the reference station 50 and each of the base stations 40 is negligible compared with the distance from the GNSS satellites thereto, it is assumed that the base stations 40 can use the same error correction information as that for the position of the reference station 50. Thus, the greater the distance between the reference station 50 and each base station 40, the lesser the accuracy of the relative GNSS positioning performed at the base stations 40. In the outdoor positioning for a closed or limited area, however, the distance between the reference station 50 and each base station 40 would be negligible. Thus, the first GNSS receiver 44 in the base station 40 may only use one signal frequency (for example, L1), or two signal frequencies (for example, L1 and L2), which makes the base stations 40 less expensive than base stations 10.

Accordingly, using the reference station 50, it is possible for the base stations 40 to use a simple radio or wireless receiver to receive the error correction information from the reference station 50, without using the Internet, mobile phone communication system, or other public communication systems, realizing the independent, precise positioning of the base stations 40 as a whole within the outdoor positioning system 200. This embodiment may further reduce the cost of implementing the outdoor positioning system 200, though the outdoor positioning system 100 provides a simpler and easier set up.

In the system 100 show in FIG. 1, since the base stations 10 are able to obtain their own current precise position (installation location) solely based on the GNSS signals received from the GNSS satellites 60, there is no need to perform survey work or measurement for the installation location in order to create an outdoor positioning infrastructure. In case of the base stations 40, as shown in FIG. 4, it is possible to conduct initial RTK positioning using the correction information obtained from the reference station 50 within the outdoor positioning area, without the Internet connection or the like which is otherwise necessary to receive error correction information.

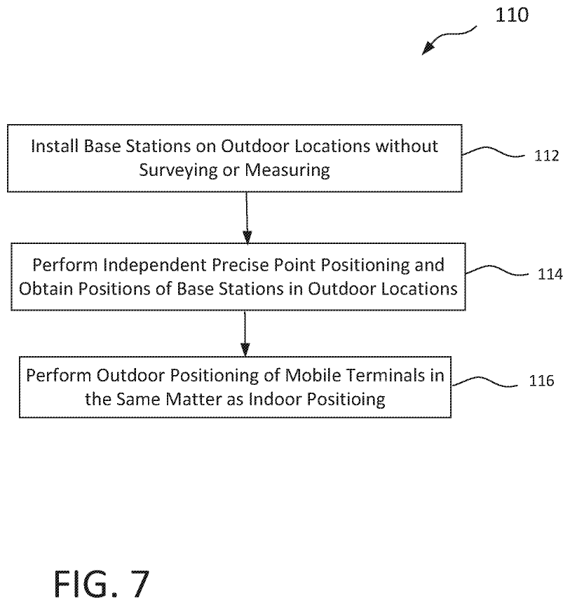

FIG. 7 illustrates a method 110 in accordance with one embodiment of the present invention. The method 110 provides, as shown in FIG. 7, outdoor positioning for a plurality of mobile terminals using an indoor positioning system. This method may be performed using the system 100 discussed above. As shown in FIG. 7, a plurality of base stations are installed on respective outdoor locations in a certain outdoor area without surveying or measuring the installed location thereof (112), where the base stations are configured to use a predetermined communications link for indoor positioning at indoor locations. Independent precise positioning is performed for each of the plurality of base stations using a plurality of GNSS signals, thereby determining a precise position of the outdoor location of each base station (114) without surveying or measuring the installed location thereof. Outdoor positioning of the plurality of mobile terminals in the outdoor area is performed (116), using the determined precise position of each of the plurality of base stations, in a same manner as the indoor positioning. This is done by receiving, at the plurality of base stations, signals from the respective mobile terminals via the predetermined communications link.

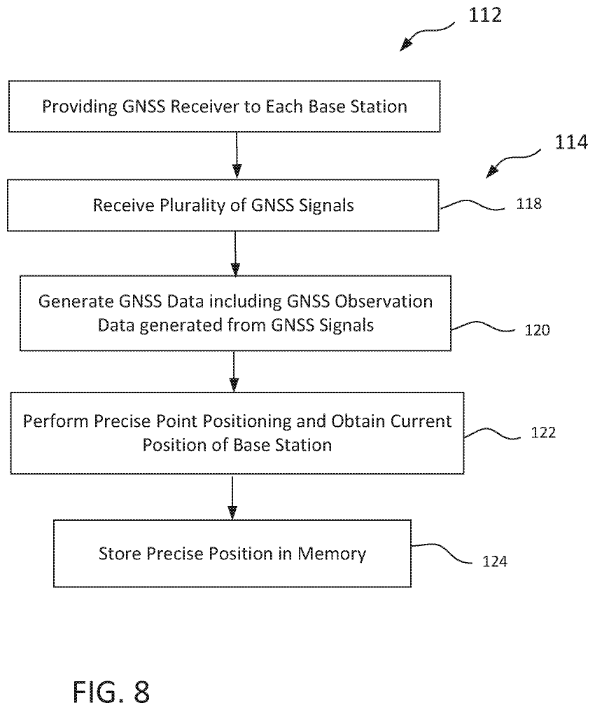

In the method 110, the installing the plurality of base stations on the respective outdoor locations (112) may be done by providing each of the plurality of base stations with a GNSS receiver configured to perform the independent precise positioning. As shown in FIG. 8. performing the independent precise positioning (114) includes receiving, by the GNSS receiver, the plurality of GNSS signals from a plurality of GNSS satellites via a GNSS antenna (118), so as to generate GNSS data (120), and performing positioning based on the GNSS data to calculate a position of the base station (112) without using position information of a reference station or external correction information received from a reference station. The determined precise position of the base station may be stored in a memory (124).

The plurality of GNSS signals may include GNSS signals having centimeter-level augmentation information, where the GNSS data includes GNSS observation data and augmentation data obtained from the augmentation information. The independent precise positioning may be precise Point Positioning (PPP) or Precise Point Positioning—Real Time Kinetic (PPP-RTK).

In accordance with one embodiment of the present invention, the method 110 further includes providing an indoor positioning mode and an outdoor positioning mode to each base station, and storing, for each base station, position information of the indoor location of the base station which is known or has been measured for the indoor positioning mode, in addition to position information of the precise position of the outdoor location determined after installing the base station in the outdoor positioning mode. The position information of the precise position of the outdoor location may include absolute position of the base station.

The predetermined communications link may be Bluetooth Low Energy using 2.4 GHz range radio frequencies, or Ultra Wideband communication using 8.5 to 9.5 GHz radio frequencies, but other communications links such as Wi-Fi may also be used.

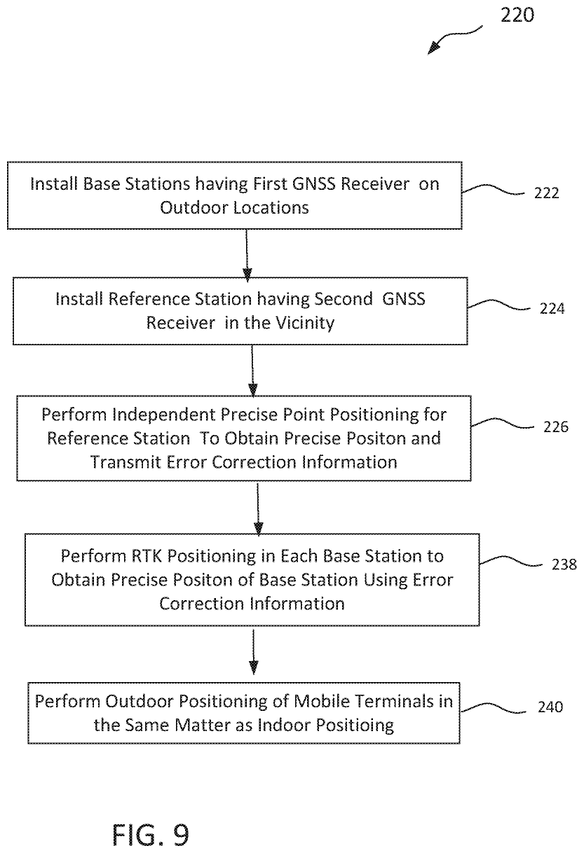

FIG. 9 illustrates a method 220 in accordance with another embodiment of the present invention. The method 220 installs the plurality of base stations on the respective outdoor locations in a manner different from that in the method 110. This method 220 may be performed using the outdoor positioning system 200. In the method 220, as shown in FIG. 9, the bases stations each provided with a first GNSS receiver configured to perform Real Time Kinematic (RTK) positioning are installed on respective outdoor locations (222), and at least one reference station including a second GNSS receiver is installed in a vicinity of the plurality of base stations (224). Then, using the second GNSS receiver, the independent precise positioning is performed (226).

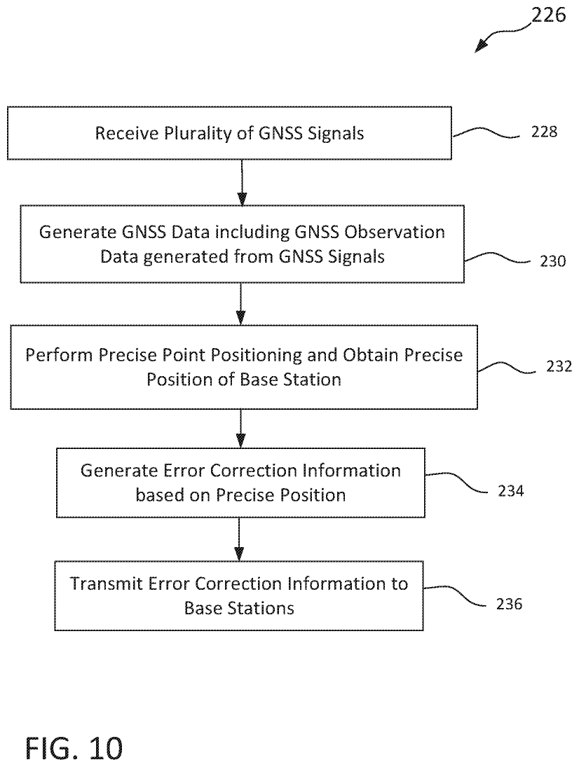

In this case, the independent precise positioning (226) performed by the second GNSS receiver includes, as shown in FIG. 10, receiving the plurality of GNSS signals including centimeter-level augmentation information (228), generating GNSS data from the received GNSS signals (230), the GNSS data including GNSS observation data and augmentation data obtained from the augmentation information, performing positioning based on the GNSS data to calculate a precise position of the reference station (232) without using position information of another reference station or external error correction information from another references station, generating error correction information in a predetermined data format (234) based on results of the positioning, the error correction information including the precise position of the reference station, and transmitting the error correction information to the respective base stations (236) via a suitable communications link. Then, referring back to FIG. 9, the RTK positioning is performed at each base station using the first GNSS receiver (238), using the error correction information received from the reference station, thereby calculating a position of the base station as the precise position of the outdoor location. The predetermined data format may be in accordance with standard correction data format of RTCM or CMR. Then, the outdoor positioning for the mobile terminals is performed using the base stations in the same manner as the indoor positioning (240).

In accordance with the system 100 and method 110 of the present invention, it is possible to provide an outdoor positioning infrastructure by simply bringing the indoor positioning system including the plurality of base station 10 to an outdoor area, and installing the base stations 10 on respective outdoor locations without measuring or surveying the position of the outdoor location, since each of the base stations 10 is capable of performing the independent precise positioning to determine its own location using the plurality of GNSS signals. Accordingly, the same mobile terminals (tags) 20 can be used in the outdoor positioning as well as the indoor positioning, realizing a seamless indoor-outdoor positioning. In addition, absolute position (coordinates) of each base station 10 may be obtained which is easily associated in a physical location of the outdoor area or field.

When the outdoor positioning is performed for a predetermined closed area such as an outdoor sports field, construction site, farm, agricultural field, and the like, it may not be necessary to perform the GNSS-based positioning for each of the positioning targets within such a limited area. In accordance with the embodiments of the present invention, the base stations are easily set up without conducting cumbersome measurement or survey to provide a suitable outdoor infrastructure.

Alternatively, the position of each base station may be determined as a relative position among the base stations, for example, when the system 200 and method 210 are employed, and the base station position is expressed as a relative position with respect to the precise position of the reference station 50. However, by determining the absolute positions (coordinates) of the respective base stations (outdoor installation location thereof), the positions of the base stations can be associated with that of the specific area for the outdoor positioning (or the ground) so as to observe or manage the movement of the mobile terminals (i.e., the positioning targets) with respect to the specific area. For example, movement of athletes such as football players with respect to the football field can be tracked, monitored, and/or recorded, by providing the mobile terminals (tags) to the athletes and installing the base stations around the field. For example, the tags can be attached to uniforms, headgears, shoes, and the like.

By employing the present invention, an indoor positioning system for an indoor sports filed can be transported to an outdoor sports field, and an outdoor positioning system is easily constructed using the same base stations and the mobile terminals, saving the cost for separately implementing the indoor and outdoor positioning systems.

The present invention may also be used for agricultural applications, in which, for example, a tractor may be provided with a mobile terminal (tag), and the base stations can be installed in a garage (indoor positioning), and around and/or along a road and fields (outdoor positioning) where the tractor travels and is operated. The tractor will be positioned seamlessly from the garage to the field and back to the garage. Automatic carrier vehicles can also be provided with the tags, and the locators (base stations) can be installed in an indoor factory and an outdoor site such that the indoor-outdoor positioning infrastructure is seamlessly and easily provided for the automatic carrier vehicles.

While this invention has been described in terms of several preferred embodiments, there are alterations, permutations, modifications, and various substitute equivalents, which fall within the scope of this invention. It should also be noted that there are many alternative ways of implementing the methods and apparatuses of the present invention. It is therefore intended that the following appended claims be interpreted as including all such alterations, permutations, and various substitute equivalents as fall within the true spirit and scope of the present invention.

What is claimed is:

1. A method for providing outdoor positioning for a plurality of mobile terminals using an indoor positioning system including a plurality of base stations, the method comprising:
installing the plurality of base stations on respective outdoor locations in an outdoor area, the base stations being configured to use a predetermined communications link for indoor positioning at indoor locations;
performing independent precise positioning for each of the plurality of base stations using a plurality of GNSS signals, thereby determining a precise position of the outdoor location of each base station without surveying or measuring the installed location thereof; and
performing outdoor positioning of the plurality of mobile terminals in the outdoor area using the determined precise position of each of the plurality of base stations in a same manner as the indoor positioning, by receiving, at the plurality of base stations, signals from the respective mobile terminals via the predetermined communications link.

2. The method according to claim 1, wherein the installing the plurality of base stations on the respective outdoor locations includes:
providing each of the plurality of base stations with a GNSS receiver configured to perform the independent precise positioning.

3. The method according to claim 2, wherein the performing independent precise positioning comprises:
receiving, by the GNSS receiver, the plurality of GNSS signals from a plurality of GNSS satellites via a GNSS antenna so as to generate GNSS data; and
performing positioning based on the GNSS data to calculate a current position of the base station without using position information of a reference station or external correction information received from a reference station.

4. The method according to claim 2, wherein the plurality of GNSS signals include GNSS signals having centimeter-level augmentation information, and wherein the GNSS data includes GNSS observation data and augmentation data obtained from the augmentation information.

5. The method according to claim 1, wherein the independent precise positioning includes precise Point Positioning (PPP) or Precise Point Positioning—Real Time Kinetic (PPP-RTK).

6. The method according to claim 1, further comprising:
providing an indoor positioning mode and an outdoor positioning mode to each base station; and
storing, for each base station, position information of the indoor location of the base station, the indoor location being known or has been measured for the indoor positioning mode, and position information of the precise position of the outdoor location of the base station, the outdoor location being determined after installing the base station in the outdoor positioning mode.

7. The method according to claim 6, wherein the position information of the precise position of the outdoor location includes absolute position of the base station.

8. The method according to claim 1, the predetermined communications link includes at least one of:
Bluetooth Low Energy using 2.4 GHz range radio frequencies; and
Ultra Wideband communication using 8.5 to 9.5 GHz radio frequencies.

9. The method according to claim 1, wherein installing the plurality of base stations on the respective outdoor locations includes:
providing each of the plurality of base stations with a first GNSS receiver configured to perform Real Time Kinematic (RTK) positioning;
installing at least one reference station including a second GNSS receiver in a vicinity of the plurality of base stations;
performing, using the second GNSS receiver, the independent precise positioning including:
receiving the plurality of GNSS signals including centimeter-level augmentation information;
generating GNSS data from the received GNSS signals, the GNSS data including GNSS observation data and augmentation data obtained from the augmentation information;
performing positioning based on the GNSS data to calculate a current position of the reference station without using position information of another reference station or external error correction information from another references station;
generating error correction information in a predetermined data format based on results of the positioning, the error correction information including the current position of the reference station; and
transmitting the error correction information to the respective base stations; and
performing, at each base station using the first GNSS receiver, the RTK positioning using the error correction information, thereby calculating a position of the base station as the precise position of the outdoor location.

10. The method according to claim 9, wherein the predetermined data format is in accordance with standard correction data format of RTCM or CMR.

11. A system for providing outdoor positioning for a plurality of mobile terminals using an indoor positioning system, the system comprising:
a plurality of base stations to be installed on respective outdoor locations in an outdoor area, the plurality of base stations being configured to use a predetermined communications link for indoor positioning at indoor locations, each base station including:
a GNSS receiver configured to perform independent precise positioning using a plurality of GNSS signals so as to determine a precise position of the outdoor location of the base station without using position information of a reference station or external correction information from a reference station; and
a positioning receiver configured to receive signals from the plurality of mobile terminals within the area via the predetermined communications link, so as to perform outdoor positioning of the respective mobile terminals using the determined precise position of the base station in a same manner as the indoor positioning, thereby determining a current position of the respective mobile terminals.

12. The system according to claim 11, further comprising:
a controller configured to receive the determined current position of the mobile terminals from the plurality of the base stations.

13. The system according to claim 11, wherein each GNSS receiver is configured to receive, from a plurality of GNSS satellites, the plurality of GNSS signals including GNSS signals having centimeter-level augmentation information, thereby generating GNSS data including GNSS observation data and augmentation data, and to perform the positioning based on the GNSS data.

14. The system according to claim 11, wherein the independent precise positioning includes precise Point Positioning (PPP) or Precise Point Positioning—Real Time Kinetic (PPP-RTK).

15. The system according to claim 11, wherein each of the plurality of base stations is provided with an indoor positioning mode and an outdoor positioning mode, each base station further including a memory for storing:
position information of the indoor location of the base station which is known or has been measured for the indoor positioning mode; and
position information of the precise position of the outdoor location determined after outdoor installation of the base station in the outdoor positioning mode.

16. The system according to claim 15, wherein the position information of the precise position of the outdoor location includes absolute position of the base station.

17. The system according to claim 11, the predetermined communications link includes at least one of:
Bluetooth Low Energy using 2.4 GHz range radio frequencies; and
Ultra Wideband communication using 8.5 to 9.5 GHz radio frequencies.

18. A system for providing outdoor positioning for a plurality of mobile terminals using an indoor positioning system, the system comprising:
a plurality of base stations installed on respective outdoor locations in an outdoor area, each of the plurality of base stations including:
a positioning receiver configured to perform indoor positioning at respective indoor locations by receiving the signals from the plurality of mobile terminals via a predetermined communications link for indoor positioning; and
a first GNSS receiver configured to perform Real Time Kinematic (RTK) positioning; and
at least one reference station installed in a vicinity of the plurality of base stations, the reference station including:
a second GNSS receiver configured to perform independent precise positioning by receiving, from a plurality of GNSS satellites, a plurality of GNSS signals including GNSS signals having centimeter-level augmentation information, thereby determining a precise position of the reference station without using position information of another reference station or external correction information received from another reference station; and
a correction signal processor configured to generate error correction information in a predetermined format, the error correction information including the precise position of the reference station, and to transmit the error correction information to the respective base stations,
wherein in each of the plurality of base stations, the first GNSS receiver performs the RTK positioning using the error correction information received from the reference station, thereby calculating a position of the base station at the outdoor location, and the positioning receiver performs outdoor positioning of the respective mobile terminals based on the signals received therefrom, using the calculated position of the base station at the outdoor location in a same manner as the indoor positioning, thereby determining a current position of the respective mobile terminals.

19. The system according to claim 18, further comprising:
a controller configured to receive information of the determined current position of the mobile terminals from the plurality of the base stations.

20. The system according to claim 18, wherein the predetermined data format is in accordance with standard correction data format of RTCM or CMR.
